(19) United States
(12) Patent Application Publication
(10) Pub. No.: US 2004/0151002 A1
(43) Pub. Date: Aug. 5, 2004

(54) Light fixture

(76) Inventors: Thomas A. Garber, Mt. Pleasant, SC (US); Kenneth J. Houry, Goose Creek, SC (US)

Correspondence Address: Craig N. Killen, Nelson Mullins Riley & Scarborough, P.O. Box 11070, Columbia, SC, 29211, US

(21) Appl. No.: 10/358,624

(22) Filed: Feb. 5, 2003

(51) Int. Cl. F21S 8/06

(52) U.S. Cl. 362/405

(57) ABSTRACT

A light fixture having at least one candle assembly and a supporting base (such as a radial arm of the light fixture) that carries the candle assembly. A coupling arrangement is adapted to permit the candle assembly to be rigidly connected to the supporting base for use. In addition, the coupling arrangement allows the candle assembly to be knocked down for packaging without disconnecting the electrical wires provided for connecting the candle assembly to a source of power.

### BACKGROUND OF THE INVENTION

The present invention relates generally to the art of light fixtures.

Due to the irregular shapes of light fixtures, efficient packaging for shipment presents difficulties. Light fixtures often contain candle assemblies and other elongated members that increase their overall height. A relatively large package must be used to accommodate these elongated members for shipment. Since shipping costs generally increase with the size of the package, larger packages lead to increases in both packaging and shipping costs.

A need exists for a novel light fixture that is adapted for shipment in a relatively compact package.

### SUMMARY OF THE INVENTION

The present invention recognizes and addresses various drawbacks of prior art constructions and methods. It is thus an object of the present invention to provide a light fixture that may be configured for use with a lower profile package for shipment.

According to one aspect, the present invention provides a light fixture having a supporting base and at least one candle assembly adapted to carry an electric light source. A coupling arrangement is adapted to permit the candle assembly to be rigidly connected to the supporting base for use. The coupling arrangement also advantageously permits the candle assembly to be knocked down for packaging without disconnecting electrical wires to the candle assembly. Preferably, the coupling arrangement is adapted to permit the candle assembly to move freely to any radial position when knocked down for shipping.

Often, the candle assembly may include an elongated support member, such as a tube. Where a tube is provided, the electrical wires can advantageously extend through the tube. In addition, the coupling assembly can desirably be adapted to allow connection of the elongated support member to the supporting base without substantial rotation of the elongated support member about its longitudinal axis.

In another aspect, the present invention provides a candle assembly for a light fixture. The candle assembly includes an elongated support member having a first end and a second end. A light source socket is located at the first end of the elongated support member. A base for supporting the elongated support member is also provided. A coupling arrangement detachably connects the second end of the elongated support member to the base. The coupling arrangement includes a threaded collar engaging a retaining element.

In some exemplary embodiments, the threaded collar may have internal threads which mate with the external threads of a fixed receiver located on the base. The retaining element may comprise a bead located on the elongated support member proximate to the second end thereof.

In a further aspect, the present invention provides a method of packaging a light fixture having at least one candle assembly. First, a light fixture is placed into a shipping package. The candle assembly(s) are then detached from rigid connection with the housing of the light fixture. Next, the detached candle assembly(s) are moved to a knocked down position that lowers the overall height of the light fixture for shipping. The shipping package is then closed.

Other objects, features and aspects of the present invention are achieved by various combinations and subcombinations of the disclosed elements, which are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying drawings, in which:

FIG. 1 is an elevational view of a light fixture according to an embodiment of the present invention;

FIG. 2 is a perspective view of the light fixture of FIG. 1 packaged for shipping, with the candle assemblies in an upright position;

FIG. 3 is an enlarged view similar to FIG. 2, with the candle assemblies in a lowered position to reduce the overall height of the light fixture for shipping;

FIG. 4 is an enlarged fragmentary view of one of the candle assemblies of FIG. 3;

FIG. 5 is an exploded view of a candle assembly according to an embodiment of the present invention;

FIG. 5A is a detailed cross-sectional view of FIG. 5 in an assembled state; and

FIG. 6 is a side view of the candle assembly of FIG. 5 in an assembled state.

Repeat use of reference characters in the present specification and drawings is intended to represent same or analogous features or elements of the invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention.

The present invention provides a light fixture having candle assemblies that may be lowered to reduce the overall height of the light fixture. With a lower profile, a smaller package can be used, thereby reducing both packaging and shipping costs. While the present invention will be discussed with respect to candle assemblies of a chandelier, it should be appreciated that the teachings of the present invention could be applied to a wide variety of light fixture styles.

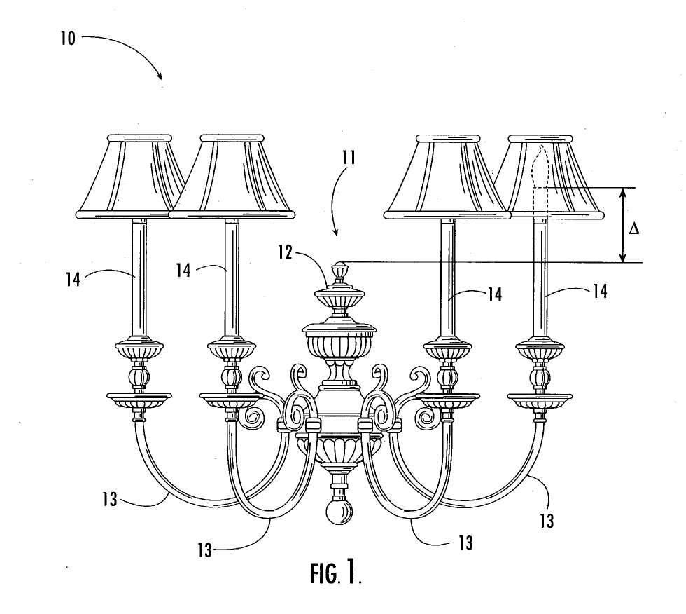

FIG. 1 shows an exemplary light fixture 10 according to the present invention. Light fixture 10 includes a frame 11 having a central portion 12 from which a plurality of radial arms 13 extend. The distal end of each radial arm 13 serves as a “base” on which a respective candle assembly 14 is mounted. In this example, candle assemblies 14 extend vertically above central portion 12 by a distance A. The candle assemblies are fixed to the frame in prior art light fixtures, therefore requiring a larger package to provide headroom sufficient to accommodate A.

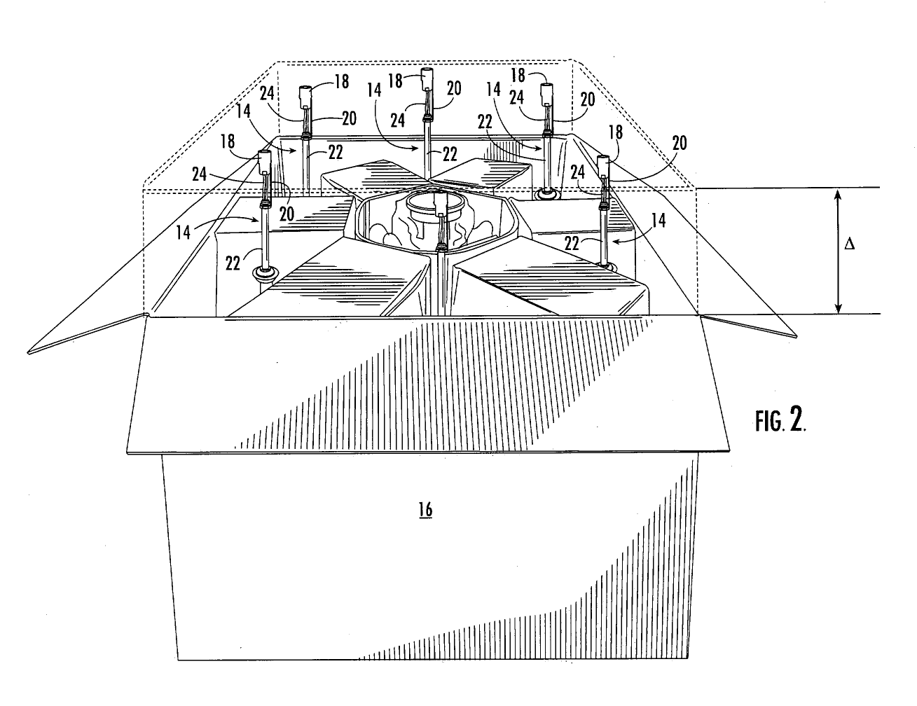

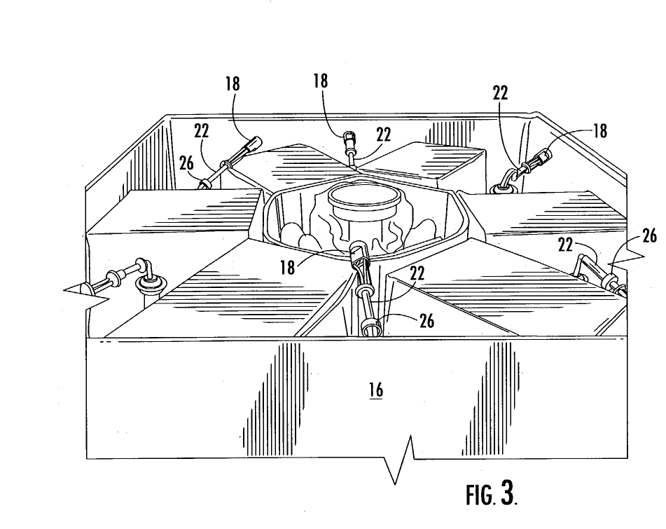

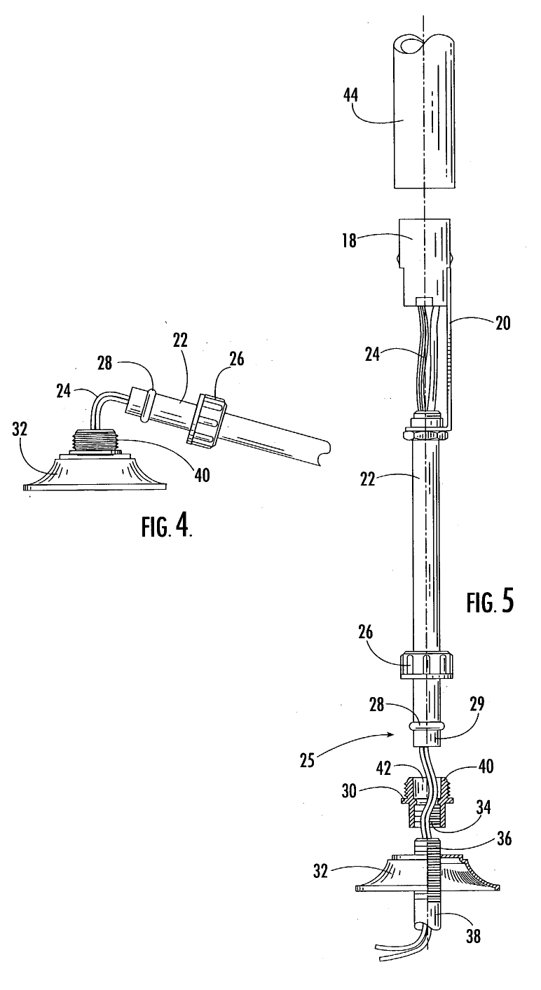

As shown in FIGS. 2-4, candle assemblies 14 of the present invention may be “knocked down” (i.e., lowered) to reduce the overall height of light fixture 10 for packaging and shipment. In this regard, FIG. 2 shows light fixture 10 placed in a package 16 but with candle assemblies 14 in an upright position. In FIG. 3, however, candle assemblies 14 have been lowered to the knocked down position. As a result, the required height of package 16 may be reduced by the distance Δ.

Referring to FIG. 5, candle assembly 14 includes a socket 18 for a light bulb (or other such light source) attached via a stand 20 to a first end of an elongated support member 22. In this case, for example, elongated support member 22 is configured as a tube. As a result, the wires 24 that connect socket 18 to a source of electrical power may advantageously extend through elongated support member 22.

In the illustrated embodiment, a coupling arrangement 25 includes a collar 26 carried by elongated support member 22. Preferably, collar 26 defines knurls (as shown) or other suitable features on its outer surface to facilitate tightening. A retaining element 28 located near the second end of elongated support member 22 is engaged by collar 26 when candle assembly 14 is in its upright, rigidly connected position. In this case, retaining element 28 is integrally formed as an annular bead extending about the circumference of member 22. Due to the location of retaining element 28, member 22 defines an insertion portion 29 between retaining element 28 and its end, as shown.

Coupling arrangement 25 includes a base coupling 30 fixed with respect to supporting base 32. In this case, base coupling 30 defines internal threads 34 which mate which external threads 36 of a rod 38. It should be appreciated, however, that base coupling 30 could be integrally formed as part of base 32.

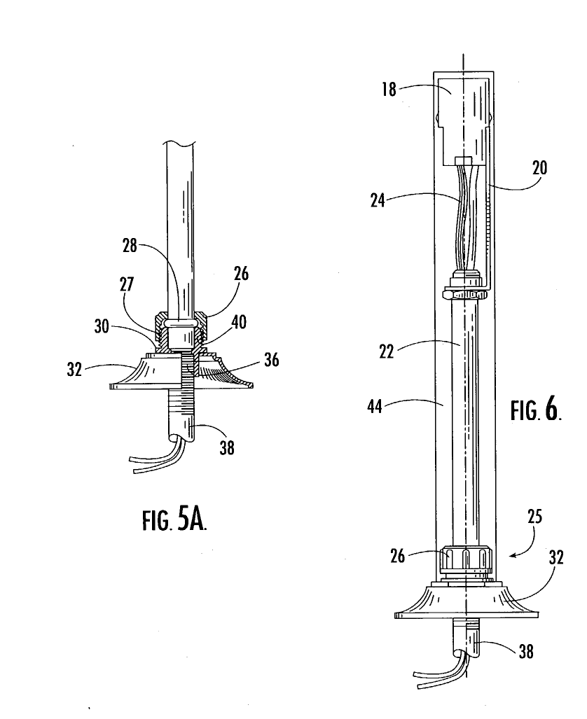

Base coupling 30 includes a receiver portion defining external threads 40. A recess 42 is dimensioned to receive insertion portion 29 of elongated support member 22. Collar 26 has internal threads 27 (FIG. 5A) that mate with external threads 40 of base coupling 30. A decorative sheath 44 may be placed over elongated support member 22 in accordance with conventional practice to simulate the appearance of a candle. FIG. 6 illustrates candle assembly 14 with elongated support member 22 rigidly connected to base 32.

In order to secure elongated support member 22 to base 32 in an upright position, insertion portion 29 is inserted into the recess 42 of base coupling 30. Collar 26 is then moved into position such that its internal threads begin to mate with the external threads of base coupling 30. After further tightening (by hand in the illustrated embodiment), candle assembly 14 will be rigidly secured to base 32. Retaining element 28 then prevents movement of elongated support member 22 in the axial direction.

As one skilled in the art will appreciate, this technique allows candle assembly 14 to be rigidly connected with, at most, only inadvertent and insubstantial rotation of elongate support member 22 about its longitudinal axis. This prevents undesirable twisting of wires 24 as the candle assembly is connected.

To package light fixture 10, collar 26 would be unscrewed from base coupling 30 to detach elongated support member 22 from base 32. As a result, elongated support member 22 may be lowered to any radial position around base 32. This gives flexibility to the worker who is packaging the light fixture to move candle assembly 14 to the best position for the particular package. Due to wires 24, candle assembly 14 advantageously remains loosely connected to the remainder of the light fixture. This prevents separation of parts which could otherwise cause them to become lost.

While preferred embodiments of the invention have been shown and described, modifications and variations may be made thereto by those of ordinary skill in the art without departing from the spirit and scope of the present invention. It should also be understood that aspects of the various embodiments may be interchanged both in whole or in part. Furthermore, those of ordinary skill in the art will appreciate that the foregoing description is by way of example only and is not intended to limit the invention as further described in the appended claims.

What is claimed is:

1. A light fixture comprising:
a supporting base;
at least one candle assembly adapted to carry an electric light source; and
a coupling arrangement adapted to permit said candle assembly to be rigidly connected to said supporting base for use but knocked down for packaging without disconnecting electrical wires for connecting said candle assembly to a source of power.

2. The light fixture as recited in claim 1, wherein said coupling arrangement permits said candle assembly to move freely to any radial position when knocked down for shipping.

3. The light fixture as recited in claim 1, wherein said candle assembly includes an elongated support member.

4. The light fixture as recited in claim 3, wherein said elongated support member comprises a tube.

5. The light fixture as recited in claim 4, wherein said electrical wires extend through said tube.

6. The light fixture as recited in claim 3, wherein said coupling assembly is adapted to allow connection of said elongated support member to said supporting base without substantial rotation of said elongated support member about its longitudinal axis.

7. The light fixture of claim 1, wherein said supporting base is located on a radially extending arm.

8. The light fixture of claim 7, comprising a plurality of said radially extending arms, each carrying a respective candle assembly.

9. A candle assembly for a light fixture, said candle assembly comprising:
an elongated support member having a first end and a second end;
a light source socket being located at said first end of said elongated support member;
a base for supporting said elongated support member; and
a coupling arrangement adapted to detachably connect said second end of said elongated support member to said base, said coupling arrangement including a threaded collar engaging a retaining element.

10. The candle assembly as recited in claim 9, wherein said elongated support member comprises a tube.

11. The candle assembly as recited in claim 10, wherein electrical wires for connecting said light source socket to a source of power extend through said tube.

12. The candle assembly as recited in claim 9, wherein said coupling arrangement assembly is adapted to allow connection of said elongated support member to said base without substantial rotation of said elongated support member about its longitudinal axis.

13. The candle assembly as recited in claim 9, wherein said threaded collar has internal threads which mate with external threads of a fixed receiver located on said base.

14. The candle assembly as recited in claim 9, wherein said retaining element comprises a bead located on said elongated support member proximate to said second end thereof.

15. A method of packaging a light fixture having at least one candle assembly, said method comprising the steps of:
(a) placing a light fixture into a shipping package;
(b) detaching at least one candle assembly from rigid connection with the housing of said light fixture;
(c) moving said detached candle assembly to a knocked down position that lowers the overall height of the light fixture for shipping; and
(d) closing the shipping package.

16. The method as recited in claim 15, wherein said candle assembly contains an elongated support member.

17. The method as recited in claim 16, wherein said elongated support member comprises a tube.

18. The method as recited in claim 17, wherein electrical wires for connecting said candle assembly to a source of power extend through said tube.
